(19) United States
(12) Patent Application Publication
(10) Pub. No.: US 2024/0310822 A1
(43) Pub. Date: Sep. 19, 2024

(54) INTEGRATED AI-ENABLED INSTRUMENT PREVENTATIVE MAINTENANCE VERIFICATION AND HEALTHINESS VALIDATION TOOL

(71) Applicant: SAUDI ARABIAN OIL COMPANY, Dhahran (SA)

(72) Inventors: Tarek D. Aboghoniem, Dhahran (SA); Abdullah A. Al-Bader, Al Mubarraz (SA); Khalid Ali Alhur, Hotouf (SA); Omar M. Mulhim, Hotouf (SA)

(73) Assignee: SAUDI ARABIAN OIL COMPANY, Dhahran (SA)

(21) Appl. No.: 18/085,306

(22) Filed: Mar. 13, 2023

(51) Int. Cl. G05B 23/02

(52) U.S. Cl. CPC G05B 23/024; G05B 23/0283

(57) ABSTRACT

A method that includes receiving process variable data from a plurality of field devices disposed in an industrial facility. The method further includes, for each field device of the plurality of field devices, retrieving a preventative maintenance procedure for the field device, retrieving a log for the field device, and determining if the field device is compliant with preventative maintenance by comparing the preventative maintenance procedure with the log for the field device. The method further includes, for each field device of the plurality of field devices, determining a status of the field device using the process variable data. The method further includes performing preventative maintenance on each field device in the plurality of field devices determined not to be compliant with the preventative maintenance procedure of that field device and operating the industrial facility based on the status of each field device in the plurality of field devices.

### BACKGROUND

Industrial facilities include a variety of field devices to monitor and control processes of the facility. Defective field devices may result in suboptimal production, production of defective or unusable facility products, and unsafe personnel work environments. As such, field devices require preventive maintenance to verify that they are operating as expected and to ensure their integrity. Preventative maintenance programs are implemented according to a time-based schedule without consideration for the current condition of the affected field devices. Further, verifying that a field device received proper preventative maintenance is a laborious process, if performed at all.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

Embodiments disclosed herein generally relate to a method that includes receiving process variable data from a plurality of field devices disposed in an industrial facility. The method further includes, for each field device of the plurality of field devices, retrieving a preventative maintenance procedure for the field device, retrieving a log for the field device, wherein the log is filtered according to a date range, and determining if the field device is compliant with preventative maintenance by, at least in part, comparing the preventative maintenance procedure with the log for the field device. The method further includes, for each field device in the plurality of field devices, determining a status of the field device using the process variable data, wherein the status further indicates an alarm priority for the field device. The method further includes performing preventative maintenance on each field device in the plurality of field devices determined not to be compliant with the preventative maintenance procedure of that field device and operating the industrial facility based on the status of each field device in the plurality of field devices.

Embodiments disclosed herein generally relate to a system that includes an industrial facility and a plurality of field devices, where the field devices are disposed in the industrial facility. The system further includes a control system, where the control system is configured to receive process variable data from at least one of the field devices in the plurality of field devices and transmit control signal data to at least one of the field devices in the plurality of field devices. The system further includes a procedures database, where the procedures database comprises preventative maintenance procedures for each of the field devices in the plurality of field devices and a control historian, where the control historian comprises a log for each of the field devices in the plurality of field devices. The system further includes a preventative maintenance verification and health validation tool configured to receive the process variable data and for each field device in the plurality of field devices: receive a preventative maintenance procedure for the field device from the procedures database; receive a log for the field device from the control historian, wherein the log is filtered according to a date range; determine if the field device is compliant with preventative maintenance by, at least in part, comparing the preventative maintenance procedure with the log for the field device; and determine a status of the field device using the process variable data, wherein the status further indicates an alarm priority for the field device.

Other aspects and advantages of the claimed subject matter will be apparent from the following description and the appended claims.

### BRIEF DESCRIPTION OF DRAWINGS

Specific embodiments of the disclosed technology will now be described in detail with reference to the accompanying figures. Like elements in the various figures are denoted by like reference numerals for consistency.

FIG. 1 depicts a gas processing plant in accordance with one or more embodiments.

FIG. 2 depicts a system in accordance with one or more embodiments.

FIG. 3 depicts a flowchart in accordance with one or more embodiments.

FIG. 4 depicts a report in accordance with one or more embodiments.

FIG. 5 depicts a neural network in accordance with one or more embodiments.

FIG. 6 depicts a method of evaluating the health of one or more field devices in accordance with one or more embodiments.

FIG. 7 depicts a dashboard in accordance with one or more embodiments.

FIG. 8 depicts a flowchart in accordance with one or more embodiments.

FIG. 9 depicts a system in accordance with one or more embodiments.

### DETAILED DESCRIPTION

In the following detailed description of embodiments of the disclosure, numerous specific details are set forth in order to provide a more thorough understanding of the disclosure. However, it will be apparent to one of ordinary skill in the art that the disclosure may be practiced without these specific details. In other instances, well-known features have not been described in detail to avoid unnecessarily complicating the description.

Throughout the application, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as using the terms “before,” “after,” “single,” and other such terminology. Rather, the use of ordinal numbers is to distinguish between the elements. By way of an example, a first element is distinct from a second element, and the first element may encompass more than one element and succeed (or precede) the second element in an ordering of elements.

It is to be understood that the singular forms “a,” “an,” and “the” include plural referents unless the context clearly dictates otherwise. Thus, for example, reference to “acoustic signal” includes reference to one or more of such acoustic signals.

Terms such as “approximately.” “substantially,” etc., mean that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

It is to be understood that one or more of the steps shown in the flowchart may be omitted, repeated, and/or performed in a different order than the order shown. Accordingly, the scope disclosed herein should not be considered limited to the specific arrangement of steps shown in the flowchart.

Although multiple dependent claims are not introduced, it would be apparent to one of ordinary skill that the subject matter of the dependent claims of one or more embodiments may be combined with other dependent claims.

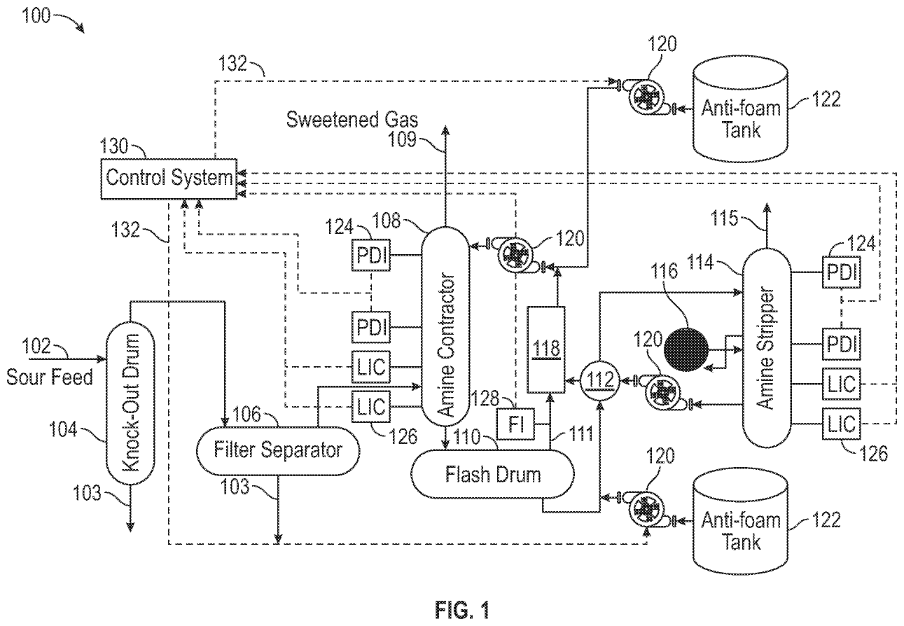

In the following description of FIGS. 1-9, any component described with regard to a figure, in various embodiments disclosed herein, may be equivalent to one or more like-named components described with regard to any other figure. For brevity, descriptions of these components will not be repeated with regard to each figure. Thus, each and every embodiment of the components of each figure is incorporated by reference and assumed to be optionally present within every other figure having one or more like-named components. Additionally, in accordance with various embodiments disclosed herein, any description of the components of a figure is to be interpreted as an optional embodiment which may be implemented in addition to, in conjunction with, or in place of the embodiments described with regard to a corresponding like-named component in any other figure.

Industrial facilities include a variety of field devices to monitor and control processes of the facility. Examples of industrial facilities may include, but are not limited to, materials processing plants (e.g., refineries), logistical centers (e.g., shipping warehouses), telecommunications centers (e.g., servers, databases, associated cooling systems), and manufacturing plants (e.g., metalwork, equipment construction, etc.). Accurate field device data and control is critical to ensure that an industrial facility operates optimally and safely. Defective field devices may result in suboptimal production, production of defective or unusable facility products, and unsafe personnel work environments.

Field devices require preventive maintenance to verify that they are operating as expected and to ensure their integrity. A preventative maintenance program may be created and applied to an industrial facility to standardize and schedule preventative maintenance steps and processes for each field device of the industrial facility. Preventative maintenance programs schedule field device preventative maintenance according to device or facility operation time without consideration for the current condition of the field devices. As such, field devices with inaccurate or degrading performance may operate until an issue is identified and corrected according to a scheduled preventive maintenance procedure, hindering the performance of the industrial facility.

Further, an industrial facility may be associated with a large number of field devices such that verifying that the field devices have received proper preventative maintenance is a time-consuming and laborious process, if performed at all. Accordingly, there exists a need to detect and identify degrading or defective field devices, alert users of the state of field devices, proactively perform preventative maintenance according to the detected state of the field devices, automatically verify that preventive maintenance steps were conducted on the field devices of an industrial facility, and identify field devices not in compliance with a preventative maintenance program.

In one aspect, embodiments disclosed herein relate to a preventative maintenance verification and health validation tool configured to receive process variable data from one or more field devices of an industrial facility. The preventative maintenance verification and health validation tool, upon receiving the process variable data, verifies whether preventative maintenance steps were correctly performed on the field devices of the industrial facility and generates a report identifying non-compliant field devices. Further, the preventative maintenance verification and health validation tool evaluates the health of the field devices and generates alarms, each with an alarm priority, according to the suspected state of the field devices. Thus, embodiments disclosed herein provide an integrated AI-based tool to proactively monitor field instruments healthiness, automatically validate preventive maintenance compliance, and report deviation or exceedances to responsible personnel. Utilizing this tool will help increase in-service life and accuracy of the field instruments, improve plant availability and reduce the number of man-hours required to carry out manual verifications of the conducted preventative maintenance.

To provide a more concrete example, FIG. 1 depicts an example industrial facility. Specifically, FIG. 1 depicts a simplified gas processing plant (100). It is emphasized that while a gas processing plant (100) and its associated field devices are provided as an example, the preventative maintenance verification and health validation tool described herein is not limited to this type of industrial facility. One with ordinary skill in the art will recognize that embodiments of the instant disclosure are applicable to any industrial facility so long as process data and/or control functionality is provided through one or more field devices. As such, the set of sub-processes and field devices shown in FIG. 1, and their arrangement, are non-limiting. Often, in an industrial facility, sub-processes encompassed by the industrial facility are often associated with a mechanical device, such as a tank or a heat exchanger. For the purposes of FIG. 1, components of the gas processing plant (100), may be described according to their function (sub-process) or their mechanical form without undue ambiguity. In other words, a tank or a drum may herein be described as a sub-process or a mechanical device.

As shown in FIG. 1, an incoming contaminated fluid (102) is sent to a gas processing plant (100) via a pipeline. The incoming contaminated fluid (102) may be called the “sour feed.” The incoming contaminated fluid (102) may be multi-phase and be composed of a variety of solid, liquid, and gaseous constituents. For example, the incoming contaminated fluid (102) may contain solid particulates like sand, mineral precipitates such as pipe scale, and corroded pipe, liquid such as water, and gases like carbon dioxide (CO2) and hydrogen sulfide (H2S). In particular, H2S, in the presence of water, is highly corrosive and should be removed to prevent a leak in the pipeline. Additionally, the incoming contaminated fluid (102) may contain liquid and gas forms of various hydrocarbons.

In the example gas processing plant (100) of FIG. 1, the incoming contaminated fluid (102), or sour feed, is processed by a knock-out drum (104). The knock-out drum (104) performs bulk separation of gas and liquid. Liquid, separated from the incoming contaminated fluid (102), exits the knock-out drum (104) through a liquid exit (103).

From the knock-out drum (104), the bulk gas is processed by a filter separator (106). A filter separator (106) removes impurities such as mineral precipitates (e.g., pipe scale), water, liquid hydrocarbons, and iron sulfide from the fluid. A filter separator (106) uses filter elements, such as a replaceable sock or a coalescing filter, rather than mechanical components to separate out contaminants. According to the application, a filter separator (106) may be composed of 1 or 2 stages and may operate at high or low pressure. Again, the unwanted portions of the incoming contaminated fluid (102) exit the filter separator (106) through an exit (103).

After the filter separator (106), the incoming contaminated fluid (102) has been reduced to a gaseous stream. The gaseous stream undergoes another purifying sub-process through an amine contactor (108). An amine contactor (108) absorbs carbon dioxide (CO2) and/or hydrogen sulfide (H2S) contaminants from the gaseous stream. In general, an amine contactor (108), receives the partially processed incoming contaminated fluid (102), or gaseous stream, and a “lean” amine liquid. Common amines are diethanolamine (DEA), monoethanolamine (MEA), methyldiethanolamine (MDEA), diisopropanolamine (DIPA), and aminocthoxyethanol (Diglycolamine) (DGA). The contact between the gaseous stream and the lean amine liquid drives the absorption of CO2 and/or H2S into the amine liquid from the gaseous stream. As a result, decontaminated gas (109), also known as “sweetened gas,” may exit the amine contactor (108). The decontaminated gas (109) should be checked to make sure it meets specifications. If the decontaminated gas (109) does not meet specifications, this is indicative that control parameters within the gas processing plant (100) require adjustment. The sub-processes of the knock-out drum (104), filter separator (106), and amine contactor (108) effectively transform the incoming contaminated fluid (102) to a decontaminated gas (109) and complete the objective of the gas processing plant (100). However, additional processes are required to maintain the gas processing plant (100) in an operational state. For example, the liquid amine that has absorbed the unwanted CO2 and H2S, which is called “rich” amine, is sent to an amine stripper for removal of its contaminants and re-conditioning.

As shown in FIG. 1, the contaminated amine is first sent to a flash drum (110). This sub-process consists of throttling the contaminated amines causing a pressure drop such that vapors are formed. The vapors exit the flash drum where they undergo further processing, such as being passed to an oxidizer. These steps have been omitted from FIG. 1 for brevity.

The remaining liquid contaminated amines enter a heat exchanger (112). The heat exchanger (112) recovers heat from the decontaminated amine leaving the amine stripper (114), which is described below. Consequently, the heat exchanger (112) heats the contaminated amine before entering the amine stripper (114).

The amine stripper (114) serves to remove the absorbed contaminants, such as H2S and CO2, from the amine solution so that it can be used again in the amine contactor (108). The amine stripper (114) is equipped with a reboiler (116). The amine stripper (114) contains a tray column consisting of a stripping section and a water wash section at the top. The reboiler (116) takes the amine solution located at the bottom of the amine stripper (114) and partially boils it. Steam (hot, gaseous water) is typically used as the heat source in the reboiler (116). Steam, typically sourced from the reboiler (116), flows up the column in the amine stripper (114) and contacts the contaminated amine solution flowing down within the column. As the contaminated amine contacts the steam, it is heated up and the contaminants are stripped out of the rich amine solution and flow to the stripping section of the column.

The stripped gases, commonly referred to as amine acid gas, leaves the amine stripper through a stripped gas exit (115). The stripped gases undergo further processing, such as condensing out the water and passing the remaining acid gases to a sulfur recovery process, but these processes are not shown in FIG. 1 for brevity.

The decontaminated amine solution, leaving the bottom of the amine stripper (114), contains very low quantities of acid gas (such as H2S). This decontaminated amine solution may be recycled in a lean amine storage tank (not shown) and/or returned to the amine contactor (108). As shown in FIG. 1., the decontaminated amine solution leaving the amine stripper (114) is passed through the heat exchanger (112), to transfer heat to the contaminated amine solution leaving the flash drum (110). After passing through the heat exchanger (112), the decontaminated amine solution may be further cooled in a cooler (118) before being returned to the amine contactor (108).

The transport of the various fluids of the gas processing plant of FIG. 1 is facilitated by a plurality of pumps and/or compressors (120) disposed throughout the system. The type of pump or compressor (120), and the location may be altered and arranged according to plant-specific needs.

It is noted that a gas processing facility (100) may implement different sub-processes and mechanisms for achieving adequate gas processing than those previously described. Some sub-processes may include compression, stabilization, and dehydration. The gas processing plant (100) may also encompass the treatment of removed water for disposal through sub-processes such as filtration and deionization. Additionally, elements for heating and cooling may be provided to prevent the formation of hydrates, and mitigate corrosion and aid in dehydration, respectively. With respect to decontaminating the incoming contaminated fluid (102), other chemical and physical washes may be used.

As shown in FIG. 1, the sub-processes may be monitored and controlled by a variety of sensors and controllers. Herein, a sensor device (i.e., a device capable of performing a measurement) and/or control device (i.e., a device governing the behavior of a sub-process) is referred to as a field device. For example, the amine contactor (108) and amine stripper (114) are both equipped with pressure differential indicators (PDI) (124) and level indicators (LIC) (126) in FIG. 1. Additionally, FIG. 1 depicts a flow indicator (FI) (128) connected to the exit of the flashed gases exiting the flash drum (110). The PDIs, LICs, and FIs, which are field devices, may send information regarding the pressure difference measured across sub-processes, the quantity and level of fluids present, and the flow rate of fluids, respectively, to a control system (130). The control system (130), in turn, may send signals to various field devices to alter and control the sub-processes of the gas processing plant (100). That is, the control system (100) is connected to, and interacts with, the field devices.

The control system (130) may be distributed, local to the sub-processes and associated device, global, connected, etc. The control system (130) may include a programmable logic controller (PLC), a distributed control system (DCS), a supervisory control and data acquisition (SCADA), and/or a remote terminal unit (RTU). For example, a programmable logic controller (PLC) may control valve states, fluid levels, pipe pressures, warning alarms, and/or pressure releases throughout a gas processing plant (100). In particular, a programmable logic controller (PLC) may be a ruggedized computer system with functionality to withstand vibrations, extreme temperatures, wet conditions, and/or dusty conditions, for example, around a refinery. A distributed control system may be a computer system for managing various sub-processes at a gas processing plant (100) using multiple control loops. As such, a distributed control system may interact with various field devices positioned at different locations throughout the facility to manage operations and monitor processes. Likewise, a distributed control system may include no single centralized computer for managing control loops and other operations. On the other hand, a SCADA system may include a control system (130) that includes functionality for enabling monitoring and issuing of process commands through local control at a gas processing facility (100) as well as remote control outside the facility. With respect to an RTU, an RTU may include hardware and/or software, such as a microprocessor, that connects field devices using network connections to perform various processes in the automation system.

FIG. 1 also depicts anti-foam tanks (122) which contain an anti-foaming agent that may be injected, by use of a pump (120) and the control system (130), into different parts of the gas processing system as indicated by the dashed line (132). The anti-foam tanks (122) and injection of an anti-foaming agent into the sub-processes of the gas processing plant (100) may be necessary because a frequent problem in gas processing plants (100) is foaming. This problem is usually the result of improper operating conditions in the sub-processes in conjunction with the presence of contaminants. A common mitigative action is to inject an anti-foaming agent into the system.

As seen in the example of FIG. 1, field devices of an industrial facility are used to monitor and control sub-processes of the industrial facility. In one or more embodiments, field devices of an industrial facility are broadly categorized as either “input” or “output” devices depending on if they provide data to a control system (130) or if they receive control instructions from the control system (130) and govern the behavior of associated sub-processes, respectively. TABLE I provides a list of common field devices along with a description of their purpose or function and their broad classification as either an input or output device. It is noted that the field devices of listed in TABLE I are not exhaustive and that one with ordinary skill in the art will appreciate that additional field devices may be used without departing from the scope of this disclosure. Further, some field devices may be considered to possess both input and output functionality.

TABLE I
Common field devices with description and broad classification.

| | | Class (Input or |
|---|---|---|
| Field Device | Description | Output) |
| Temperature | Device used to transmit temperature measurement | Input |
| transmitter | from field temperature sensor (i.e., thermocouple) to | |
| | the control system (130). | |
| Level | Device used to transmit level measurement of a tank | Input |
| Transmitter | or vessel from a level sensor (a level float) to the | |
| | control system (130). | |
| Flow | Device used to transmit flow measurement in a | Input |
| Transmitter | process line from a flow sensor (e.g., orifice plate) to | |
| | the control system (130). | |
| Pressure | Device used to transmit pressure measurement from a | Input |
| Transmitter | pressure gauge in a process line to the control system | |
| | (130). | |
| Pressure Switch | Switch operates an electric contact when certain | Input |
| | pressure has reached a preconfigured set point. | |
| Level Switch | Switch operates an electric contact when certain level | Input |
| | has reached a preconfigured set point | |
| Temperature | Switch operates an electric contact when certain | Input |
| Switch | temperature has reached preconfigured set point | |
| Flow Switch | Switch operates an electric contact when certain flow | Input |
| | has reached preconfigured set point | |
| Flow Control | Valve used to control fluid flow by varying the | Output |
| valve (FCV) | amount of the flow passage as directed by a | |
| | percentage output signal from a controller as directed | |
| | by the control system (130). | |
| Motor Operated | Motor Operated Valve (MOV) are often called as On- | Output |
| Valve | Off valves as the motors serve the purpose of fully | |
| (MOV) | opening or fully closing valves in pipelines. | |
| Shutdown Valve | Actuated valve which is closed during partial or total | Output |
| (ZV) | process shutdown of system to which the valve | |
| | protects (safety isolation valves). | |
| Aire Operated | An air-operated valve, also known as a pneumatic | Output |
| Valve (AOV) | valve, is a type of power-operated pipe valve that uses | |
| | air pressure to perform a function similar to a | |
| | solenoid. | |

Herein, for concision, the collection of all sensory data acquired by field devices of an industrial facility is referred to as process variable data. Generally, but without limitation, the process variable data consists of measurements acquired and/or transmitted by field devices classified as an input device. Likewise, the collection of all signals produced by a control system (130) and provided to one or more field devices is referred to herein as control signal data. Again, in general and without limitation, the control signal data consists of signals sent from the control system (130) to field devices classified as output devices.

One with ordinary skill in the art will recognize that some field devices may be associated with both process variable data and control signal data. In accordance with one or more embodiments, a preventative maintenance verification and health validation tool is configured to receive process variable data from one or more field devices of an industrial facility and to interact with one or more systems associated with the industrial facility (e.g., control system (130)).

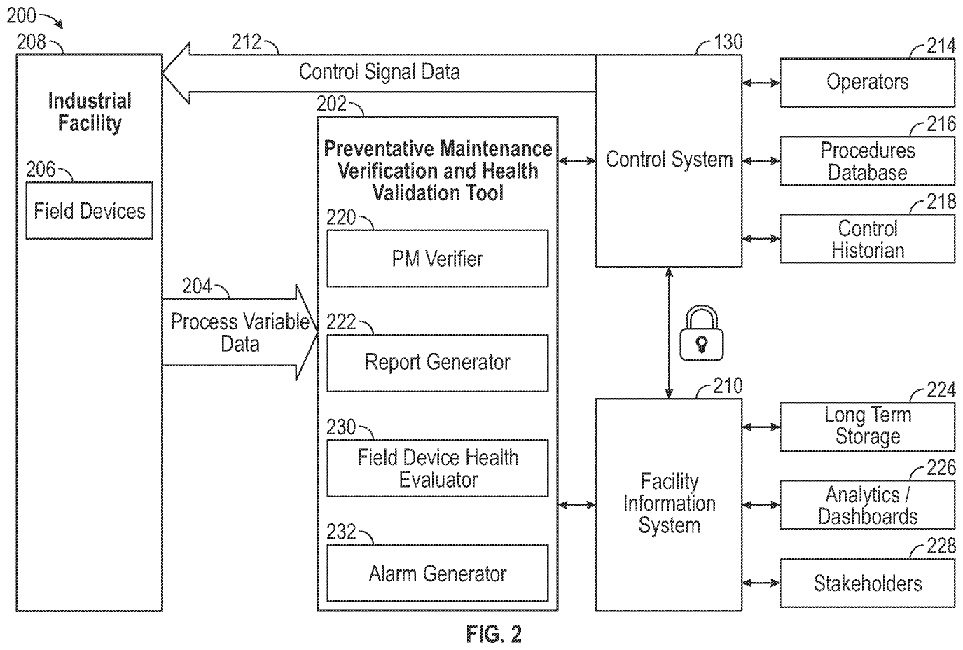

FIG. 2 depicts a preventative maintenance (PM) verification and validation system (200), in accordance with one or more embodiments. The PM verification and validation system (200) provides greater context for the preventative maintenance verification and health validation tool (202) and other external systems with which it may interact. However, one with ordinary skill in the art will recognize that the interaction of the preventative maintenance verification and health validation tool (202) with external systems may be configured in a variety of ways such that the PM verification and validation system (200) shown in FIG. 2 does not impose a limitation on the instant disclosure. The preventative maintenance verification and health validation tool (202) is configured to receive process variable data (204) from the field devices (206) of an industrial facility (208). The preventative maintenance verification and health validation tool (202) can interact with the control system (130) and a facility information system (210). Herein, interaction between the preventative maintenance verification and health validation tool (202) and the control system (130) and the facility information system (210) includes, at least, the ability to pass data between systems.

For example, in one or more embodiments, the process variable data (204), upon being received by the preventative maintenance verification and health validation tool (202), is passed directly to the control system (130). All such depictions of interactions between elements of FIG. 2 indicate that said elements may communicate and pass data and/or other information between each other.

The control system (130), as previously described in FIG. 1, may receive process variable data (204) and transmit control signal data (212) to and from the field devices (206) of the industrial facility (208). Generally, the control system (130) is continuously monitored by one or more operators (214) that may interact with the control system (130) to perform various operator actions. In accordance with one or more embodiments, the control system (130) is further connected to a procedures database (216) and a control historian (218). The procedures database (216) contains individualized preventative maintenance (PM) procedures for each field device (206) in the industrial facility (208). A PM procedure outlines the steps, which may be ordered, that should be undertaken to perform PM on a given field device. As an example, the PM procedure for a field transmitter (an input device) may include the steps depicted in TABLE II. Likewise, as an example, the PM procedure for a control valve with a feedback signal (an output device) may include the steps depicted in TABLE III.

TABLE II
Example PM procedure for field transmitter.

| Step Number | Step | Description |
|---|---|---|
| 1 | Control system (130) | Bypass shall be initiated for subject field |
| | console operator shall | transmitter to eliminate the use of this field |
| | initiate bypass override | transmitter in the control system (130) |
| | | logic which could cause process upset |
| 2 | Outside maintenance | LOW reading shall be initiated in the field |
| | personnel shall simulate | transmitter by maintenance personnel and |
| | “LOW” reading | matching reading is confirmed at control |
| | | system (130) |
| 3 | Outside maintenance | Outside maintenance personnel shall |
| | personnel shall simulate | simulate LOW LOW in the field |
| | “LOW LOW” reading | transmitter and matching reading is |
| | | confirmed at control system (130) |
| 4 | Outside maintenance | HIGH reading shall be initiated in the field |
| | personnel shall simulate | transmitter matching reading is confirmed |
| | “HIGH” reading | at control system (130) |
| 5 | Outside maintenance | HIGH HIGH reading shall be initiated in |
| | personnel shall simulate | the field transmitter and matching reading |
| | “HIGH HIGH” reading | confirmed at control system (130) |
| 6 | Outside maintenance | Bypass for subject field transmitter is |
| | personnel return field | removed and field transmitter is used in |
| | transmitter to in-service | control system (130) logic |
| | state | |

TABLE III
Example PM procedure for control valve with feedback signal.

| Step Number | Step | Description |
|---|---|---|
| 1 | Control system (130) | Control valve shall be switched from auto |
| | console operator shall | to manual operation to allow control |
| | switch control valve | system (130) operator to manipulate the |
| | from auto to manual | output values to the control valve |
| | operation | |
| 2 | Control system (130) | Control valve output shall be set to zero by |
| | operator shall set control | control system (130) operator and compare |
| | valve output to 0% | set value with the feedback signal received |
| | | from the control valve |
| 3 | Control system (130) | Control valve output shall be set to 25% by |
| | operator shall set control | the control system (130) operator and |
| | valve output to 0% | compare set value with the feedback signal |
| | | received from the control valve |
| 4 | Control system (130) | Control valve output shall be set to 50% by |
| | operator shall set control | control system (130) operator and compare |
| | valve output to 0% | set value with the feedback signal received |
| | | from the control valve |
| 5 | Control system (130) | Control valve output shall be set to 75% by |
| | operator shall set control | control system (130) operator and compare |
| | valve output to 0% | set value with the feedback signal received |
| | | from the control valve |
| 6 | Control system (130) | Control valve output shall be set to 100% |
| | operator shall set control | by control system (130) operator and |
| | valve output to 0% | compare set value with the feedback signal |
| | | received from the control valve |
| 7 | Control system (130) | Control valve shall be switched back from |
| | console operator shall | manual to auto to allow control system |
| | switch control valve | (130) to direct the output values to the |
| | from manual to auto | control valve |
| | operation | |

Referring back to FIG. 2, the control historian (218) contains a timestamped log of process variable data (204) and control system operator actions. In one or more embodiments, the control historian (218) contains a separate log for each field device (206) of the industrial facility (208) of the control historian (218). Continuing with the previous examples, excerpts of control logs for a field transmitter and a control valve with a feedback signal are provided in TABLES IV and V, respectively. As seen in these tables, the logs of the control historian (218) contain events associated with process variable data (204), control signal data (212), and actions of operators (214) of the control system (130).

TABLE IV
Example log for a given field transmitter
over a select period of time.

| Time | Tag Name | Event | Event Type |
|---|---|---|---|
| 08:00:00 | 100TI150 | Bypass ON | Operator |
| 08:01:00 | 100TI150 | LOW Signal | Process |
| 08:01:30 | 100TI150 | LOW LOW Signal | Process |
| 08:02:00 | 100TI150 | HIGH Signal | Process |
| 08:02:30 | 100TI150 | HIGH HIGH Signal | Process |
| 08:03:00 | 100TI150 | Bypass OFF | Operator |

TABLE V
Example log for a given control valve with feedback
signal over a select period of time.

| Time | Tag Name | Event | Event Type |
|---|---|---|---|
| 08:00:00 | 100TIC250 | Manual | Operator |
| 08:01:00 | 100TIC250 | Output = 0 | Operator |
| 08:01:10 | 100TTD150 | Feedback = 0 | Feedback |
| 08:02:00 | 100TIC250 | Output = 25 | Operator |
| 08:02:10 | 100TTD150 | Feedback = 25 | Feedback |
| 08:03:00 | 100TIC250 | Output = 50 | Operator |
| 08:03:10 | 100TTD150 | Feedback = 50 | Feedback |
| 08:04:00 | 100TIC250 | Output = 75 | Operator |
| 08:04:10 | 100TTD150 | Feedback = 75 | Feedback |
| 08:05:00 | 100TIC250 | Output = 100 | Operator |
| 08:05:10 | 100TTD150 | Feedback = 100 | Feedback |
| 08:06:00 | 100TIC250 | Auto | Operator |

In one or more embodiments, the procedures database (216) and the control historian (218) are not independent components. For example, the procedures database (216) and the control historian (218) may reside on the same storage system. The preventative maintenance verification and health validation tool (202) includes a preventative maintenance (PM) verifier (220) and a report generator (222). In accordance with one or more embodiments, the PM verifier (220) may receive a PM procedure from the procedures database (216) for a specified field device (206) of the industrial facility (208). Further, the PM verifier (220) may receive the log for the specified field device from the control historian (218) over a pre-configured (or user-specified) period of time.

For example, a user may configure the preventative maintenance verification and health validation tool (202) such that any logs received from the control historian (218) are filtered to only span from the time of request to one month prior. The PM verifier (220), for a given field device, compares the control historian (218) log for the given field device to the PM procedure received from the procedures database (216). This process will be described in greater detail later in the instant disclosure, but for now, it is sufficient to say that the PM verifier (220), through comparison of the log and PM procedure for a given field device, determines whether PM was correctly performed on the field device within the period of time spanned by the log. The report generator (222) compiles the results of the PM verifier (220) applied to each of the field devices (206) of the industrial facility (208). The report generator (222) provides and exports a report detailing the compliance of each field device (206) in the industrial facility (208) to its PM procedure. Thus, the preventative maintenance verification and health validation tool (202) automates the verification that PM is correctly applied to the field devices (206) and identifies field devices (206) not in compliance with a preventative maintenance program (i.e., PM procedure applied within a given period of time). In one or more embodiments, the procedures database (216) and/or the control historian (218) may be directly integrated with, or otherwise considered a part of, the control system (130).

The facility information system (210), in accordance with one or more embodiments, resides on a Management Information System (MIS) enterprise layer with secured connectivity to the control system (130) to fetch and process data in real time. The facility information system (210) is used for long term storage (224). In one or more embodiments, the long term storage (224) stores all process variable data (204) received from the industrial facility (208). In one or more embodiments, the long term storage (224) stores aggregate or derived variables associated with the industrial facility (208). For example, process variable data (204) may be averaged over time (an aggregation) or combined through a prescribed function (derived variable) to indicate one or more properties of the industrial facility (208). In this vein, in one or more embodiments, the facility information system (210) provides analytic functionality and dashboards (226) to stakeholders (228) of the industrial facility (208). The analytics/dashboards (226) feature of the facility information system (210) allows engineers to construct data pipelines that process the process variable data (204) and illustrate the results using a dashboard. In one or more embodiments, the data pipelines and dashboards operate on process variable data (204) in real time. In accordance with one or more embodiments the facility information system (210) is accessible to a variety of stakeholders (228) associated with the industrial facility (208) regardless of their discipline. That is, stakeholders need not directly control the facility information system (210) like the operators (214) of the control system (130). Examples of stakeholders (228) may include, but are not limited to, mangers, engineers, and division heads.

While FIG. 2 depicts the long term storage (224) and analytics/dashboards (226) as independent and distinct elements, one with ordinary skill in the art will recognize that, in practice, these elements may be distinct or may be an integral part of the facility information system (210) without departing from the scope of this disclosure. That is, depictions of elements in FIG. 2 are intended to aid in the description of the of the PM verification and validation system (200) and should not be considered as boundaries.

Continuing with FIG. 2, the preventative maintenance verification and health validation tool (202) further includes a field device health evaluator (230) and an alarm generator (232). The field device health evaluator (230) receives the process variable data (204) and logs of the process variable data (204) from the control historian (218) and/or long term storage (224) and assesses the health of each field device (206) based on its recorded data. Once the health of a field device (206) is determined by the field device health evaluator (230), the state of the field device (206) (e.g., normal, suspected degraded) is returned by the preventative maintenance verification and health validation tool (202) along with an alarm generated by the alarm generator (232). In one or more embodiments, alarms are further given a priority such as high, medium, or low. In one or more embodiments, the states of the field devices (206) and generated alarms are visualized in a dashboard (226) of the facility information system (210). The field device health evaluator (230) and alarm generator (232) will be described in greater detail later in the instant disclosure.

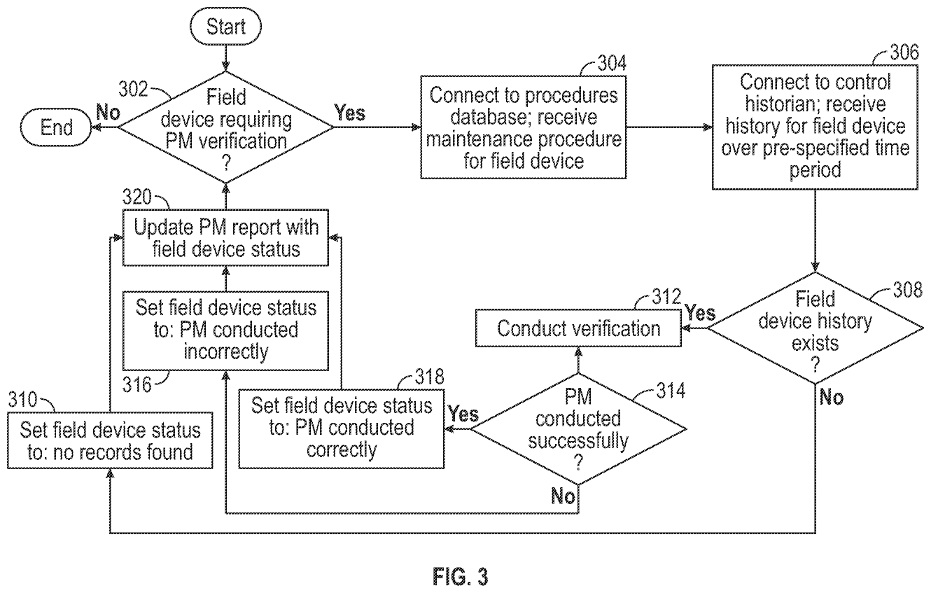

Returning to the preventative maintenance (PM) verifier (220) of the preventative maintenance verification and health validation tool (202), FIG. 3 depicts a flowchart outlining the steps employed by the PM verifier (220), in accordance with one or more embodiments. In Block 302, it is checked if any field devices require PM verification. In one or more embodiments, a list of the field devices (206) of an industrial facility (208) are provided to the PM verifier (220) such that Block 302 serves to cycle through and check each field device for PM compliance. That is, the Block 302 may be used to implement a loop, where the loop operates over a supplied list of field devices (206). In one or more embodiments, the PM verifier (220) is provided a list of field devices (206) periodically (i.e., PM verification is scheduled).

If, in Block 302, it is determined that there are no field devices (206) that require PM verification, the processes of FIG. 3 are terminated. If, in Block 302, it is determined that at least one field device (206) requires PM verification, then one field device is selected for PM verification. In Block 304, the PM verifier (220) connects to the procedures database (216) and retrieves the PM procedure for the selected field device.

Next, in Block 306, the PM verifier (220) connects to the control historian (218) and retrieves the log for the selected field device over a pre-configured (or user-specified) time period. In one or more embodiments, the PM verifier (220) retrieves the log of the selected field device that spans the period since the last time the PM verification was performed on the selected field device.

In Block 308, the PM verifier (220) ensures that a log (or history) for the selected field device exists (i.e., that log was successfully retrieved in Block 306) and that the retrieved log is not empty (i.e., the log contains at least one log entry). In Block 308, if it is determined that no log (or history) exists for the selected field device, or that the log is empty, then the status of the selected field device is set to “no records found.” If, in Block 308, a log (or history) for the selected field device exits, then verification is conducted in Block 310. Verification of preventative maintenance consists of comparing the PM procedure to the log for the selected device. For example, comparison of the PM procedure depicted in TABLE II to the log of TABLE IV indicates that the field transmitter of these tables did have PM steps applied to it according to its PM procedure. The PM verifier (220) is capable of searching through many log entries in logs to identify if, at any portion in the log, the log entries align with and comply with the PM procedure.

In one or more embodiments, a REGEX (regular expression) computational string and/or object is formed from the PM procedure and used to efficiently search the log for matches. Based on the conducted verification (Block 312), Block 314 assigns a status to the selected field device. If, in Block 314, it is determined that PM was not conducted, or otherwise conducted incorrectly (e.g., PM steps out of order or incomplete), then the status of the selected field device is set to “PM conducted incorrectly” as shown in Block 316.

If, in Block 314, it is determined that PM was correctly conducted on the selected field device, then the status of the selected field device is set to “PM conducted correctly” as shown in Block 318. With the status of the selected field device set, in Block 320 the PM report is updated with the status of the selected field device. That is, the report generator (222) has access to the status of the selected field device. The flowchart of FIG. 3 returns to Block 302 to check if any other field devices require PM verification.

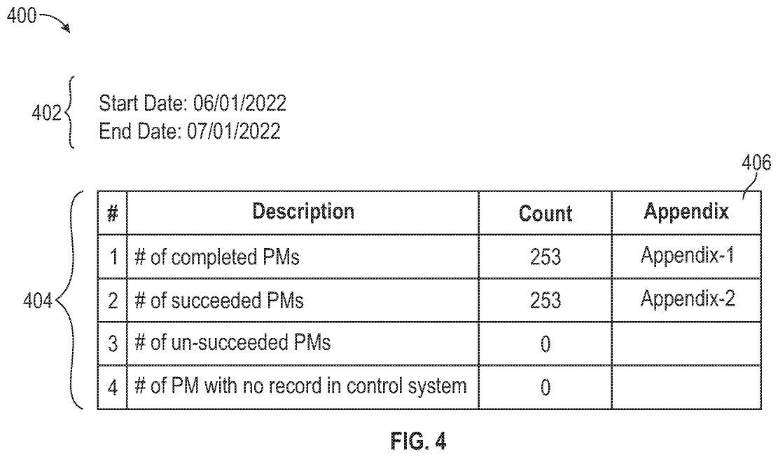

The report generator (222) compiles the results of the PM verifier (220) into a report that is provided to the operators (214) and/or stakeholders (228). In one or more embodiments, the report is made accessible through the facility information system (210) and visualized using a dashboard (226). FIG. 4 depicts an example report as produced by the report generator (222) upon completion of the PM verifier (220) as applied to the field devices (206) of an industrial facility (208). In this example, the PM verification report (400) details the time period (402) over which the PM verifier (220) was run and a high-level summary (404) indicating the total number of field devices (206) and the numbers of which had correct performed PM (successful), incorrectly performed PM (unsuccessful), and those without logs in the control system. The PM verification report (400) further provides appendices (406) that provide more information on the field devices (206) according to their statuses.

The field device health evaluator (230) uses both rules-based methods and one or more artificial intelligence (AI)-based methods to determine the health of each of the field devices (206) of the industrial facility (208). In accordance with one or more embodiments, the rules-based methods are as follows. For a given field device, a first rules-based method detects if the given field device is in a “frozen” or “halted” state. In one or more embodiments, the first rules-based method determines the rate of change of one or more process variables associated with the given field device over a pre-configured (or user-specified) period of time. In one or more embodiments, the first rules-based method determines the rate of change of the one or more process variables of the given field device over the most recent four weeks. As an example, if the field device under consideration is a pressure differential indicator (PDI) (124), the process variable is the measured and recorded differential pressure of the PDI (124) over the pre-configured period. The first rules-based method determines if the current, or most recent, rate of change of the process variable(s) of the given field device are zero. If the current rate of change is determined to be zero, the first rules-based method then determines if the rate of change of the process variable(s) was ever not zero at any point in the period. If the rate of change of the process variables(s) is currently zero and the rate of change of the process variable(s) was not zero at any time in the period, then the given field device is suspected to be in error or degraded. In one or more embodiments, the associated generated alarm of a field device with suspected degradation determined by the first rules-based method is given a high priority. In one or more embodiments, if the rate of change of the process variable(s) of the given field device is zero throughout the specified period, then it is assumed that the given field device (or portion of the industrial facility (208) local to the field device) is in a standby or out-of-service mode.

One with ordinary skill in the art will recognize that alterations to the first rules-based method or other rules-based methods may be specified that meet the intent of the first rules-based method (i.e., detection of a frozen or halted state) and do not exceed the scope of this disclosure.

Likewise, for a given field device, a second rules-based method detects deviations in the process variable(s) of the given field device. In one or more embodiments, the second rules-based method determines the rate of change of one or more process variables associated with the given field device over a pre-configured (or user-specified) period of time. In one or more embodiments, the second rules-based method determines the rate of change of the one or more process variables of the given field device over the most recent four weeks. For the second rules-based method, rate of change of the process variable(s) over the period is compared with an upper bound and lower bound, where the upper and lower bounds are unique to the given field device. If, at any point during the pre-configured period, the rate of the change of the process variable(s) of the given field device exceed either the lower bound or upper bound of the given field device, the given field device is suspected to be in error or degraded. In one or more embodiments, the associated generated alarm of a field device with suspected degradation determined using the second rules-based method is given a low priority. In one or more embodiments, the upper bound and lower bound of each field device are specified by a user. In other embodiments, the upper bound and lower bound of one or more field devices (206) are determined using historical process variable data and a user-specified function. For example, historical process variable data may be used to establish a baseline and the upper and lower bounds may be determined according to the established baseline (e.g., upper bound: 1.5×baseline, lower bound: 0.5×baseline).

As stated, the field device health evaluator (230) of the preventative maintenance verification and health validation tool (202) employs both rules-based and one or more artificial intelligence (AI)-based methods to determine the health of each of the field devices (206) of the industrial facility (208). Before discussing the one or more AI-based methods used in the field device health evaluator (230), an introductory discussion of artificial intelligence methods is provided herein. One with ordinary skill in the art will recognize that the field of artificial intelligence (AI) is both broad and deep such that a comprehensive overview of AI is not possible within a single disclosure. Thus, the introductory discussion to AI provided herein is only to provide context and aid in the discussion of the AI-based method(s) of the field device health evaluator (230) and does not represent nor impose a limitation on the instant disclosure.

Artificial intelligence (AI), broadly defined, is the extraction of patterns and insights from data. The phrases “artificial intelligence”, “machine learning”, “deep learning”, and “pattern recognition” are often convoluted, interchanged, and used synonymously throughout the literature. This ambiguity arises because the field of “extracting patterns and insights from data” was developed simultaneously and disjointedly among a number of classical arts like mathematics, statistics, and computer science. For consistency, the term artificial intelligence will be adopted herein. However, one skilled in the art will recognize that the concepts and methods detailed hereafter are not limited by this choice of nomenclature.

Artificial intelligence (AI) model types may include, but are not limited to, generalized linear models, Bayesian regression, random forests, anomaly detection algorithms, and deep models such as neural networks, convolutional neural networks, and recurrent neural networks. AI model types, whether they are considered deep or not, are usually associated with additional “hyperparameters” which further describe the model. For example, hyperparameters providing further detail about a neural network may include, but are not limited to, the number of layers in the neural network, choice of activation functions, inclusion of batch normalization layers, and regularization strength. Commonly, in the literature, the selection of hyperparameters surrounding an AI model is referred to as selecting the model “architecture”. Once an AI model type and hyperparameters have been selected, the AI model is often trained to perform a task. However, it is noted that some AI models may not require training. In accordance with one or more embodiments, one or more AI models are selected and used to process the process variable data (204) from the field devices (206) and determine the health of the field devices (206).

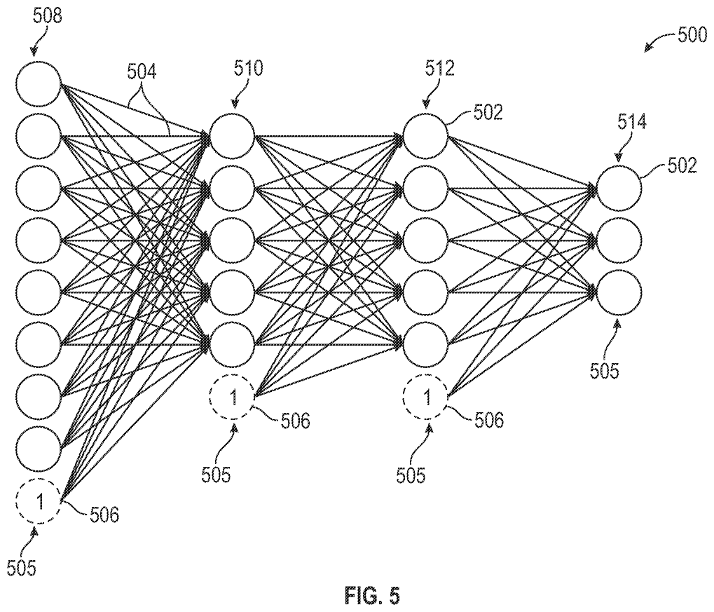

As an example of an AI model, a diagram of a neural network is shown in FIG. 5. At a high level, a neural network (500) may be graphically depicted as being composed of nodes (502), where here any circle represents a node, and edges (504), shown here as directed lines. The nodes (502) may be grouped to form layers (505). FIG. 5 displays four layers (508, 510, 512, 514) of nodes (502) where the nodes (502) are grouped into columns, however, the grouping need not be as shown in FIG. 5. The edges (504) connect the nodes (502). Edges (504) may connect, or not connect, to any node(s) (502) regardless of which layer (505) the node(s) (502) is in. That is, the nodes (502) may be sparsely and residually connected. A neural network (500) will have at least two layers (505), where the first layer (508) is considered the “input layer” and the last layer (514) is the “output layer”. Any intermediate layer (510, 512) is usually described as a “hidden layer”. A neural network (500) may have zero or more hidden layers (510, 512) and a neural network (500) with at least one hidden layer (510, 512) may be described as a “deep” neural network or as a “deep learning method”. In general, a neural network (500) may have more than one node (502) in the output layer (514). In this case the neural network (500) may be referred to as a “multi-target” or “multi-output” network.

Nodes (502) and edges (504) carry additional associations. Namely, every edge is associated with a numerical value. The edge numerical values, or even the edges (504) themselves, are often referred to as “weights” or “parameters”. While training a neural network (500), numerical values are assigned to each edge (504). Additionally, every node (502) is associated with a numerical variable and an activation function. Activation functions are not limited to any functional class, but traditionally follow the form

$$A = f ( {\sum }_{i ∈ ( incoming )} [ {( node value )}_{i} {( edge value )}_{i} ] ) , \qquad EQ 1$$

where i is an index that spans the set of “incoming” nodes (502) and edges (504) and ƒ is a user-defined function. Incoming nodes (502) are those that, when viewed as a graph (as in FIG. 5), have directed arrows that point to the node (502) where the numerical value is being computed. Some functions for ƒ may include the linear function ƒ (x)=x, sigmoid function

$$f ( x ) = \frac{1}{1 + {e}^{- x}} ,$$

and rectified linear unit function ƒ(x)=max(0, x), however, many additional functions are commonly employed. Every node (502) in a neural network (500) may have a different associated activation function. Often, as a shorthand, activation functions are described by the function ƒ by which it is composed. That is, an activation function composed of a linear function ƒ may simply be referred to as a linear activation function without undue ambiguity.

When the neural network (500) receives an input, the input is propagated through the network according to the activation functions and incoming node (502) values and edge (504) values to compute a value for each node (502). That is, the numerical value for each node (502) may change for each received input. Occasionally, nodes (502) are assigned fixed numerical values, such as the value of 1, that are not affected by the input or altered according to edge (504) values and activation functions. Fixed nodes (502) are often referred to as “biases” or “bias nodes” (506), displayed in FIG. 5 with a dashed circle.

In some implementations, the neural network (500) may contain specialized layers (505), such as a normalization layer, or additional connection procedures, like concatenation. One skilled in the art will appreciate that these alterations do not exceed the scope of this disclosure.

As noted, the training procedure for the neural network (500) comprises assigning values to the edges (504). To begin training the edges (504) are assigned initial values. These values may be assigned randomly, assigned according to a prescribed distribution, assigned manually, or by some other assignment mechanism. Once edge (504) values have been initialized, the neural network (500) may act as a function, such that it may receive inputs and produce an output. As such, at least one input is propagated through the neural network (500) to produce an output. Training data is provided to the neural network (500). Generally, training data consists of pairs of inputs and associated targets. The targets represent the “ground truth”, or the otherwise desired output, upon processing the inputs. During training, the neural network (500) processes at least one input from the training data and produces at least one output. Each neural network (500) output is compared to its associated input data target. The comparison of the neural network (500) output to the target is typically performed by a so-called “loss function”; although other names for this comparison function such as “error function”, “misfit function”, and “cost function” are commonly employed. Many types of loss functions are available, such as the mean-squared-error function, however, the general characteristic of a loss function is that the loss function provides a numerical evaluation of the similarity between the neural network (500) output and the associated target. The loss function may also be constructed to impose additional constraints on the values assumed by the edges (504), for example, by adding a penalty term, which may be physics-based, or a regularization term (not be confused with regularization of seismic data). Generally, the goal of a training procedure is to alter the edge (504) values to promote similarity between the neural network (500) output and associated target over the training data. Thus, the loss function is used to guide changes made to the edge (504) values, typically through a process called “backpropagation”.

While a full review of the backpropagation process exceeds the scope of this disclosure, a brief summary is provided. Backpropagation consists of computing the gradient of the loss function over the edge (504) values. The gradient indicates the direction of change in the edge (504) values that results in the greatest change to the loss function. Because the gradient is local to the current edge (504) values, the edge (504) values are typically updated by a “step” in the direction indicated by the gradient. The step size is often referred to as the “learning rate” and need not remain fixed during the training process. Additionally, the step size and direction may be informed by previously seen edge (504) values or previously computed gradients. Such methods for determining the step direction are usually referred to as “momentum” based methods.

Once the edge (504) values have been updated, or altered from their initial values, through a backpropagation step, the neural network (500) will likely produce different outputs. Thus, the procedure of propagating at least one input through the neural network (500), comparing the neural network (500) output with the associated target with a loss function, computing the gradient of the loss function with respect to the edge (504) values, and updating the edge (504) values with a step guided by the gradient, is repeated until a termination criterion is reached. Common termination criteria are: reaching a fixed number of edge (504) updates, otherwise known as an iteration counter; a diminishing learning rate; noting no appreciable change in the loss function between iterations; reaching a specified performance metric as evaluated on the data or a separate hold-out data set. Once the termination criterion is satisfied, and the edge (504) values are no longer intended to be altered, the neural network (500) is said to be “trained.”

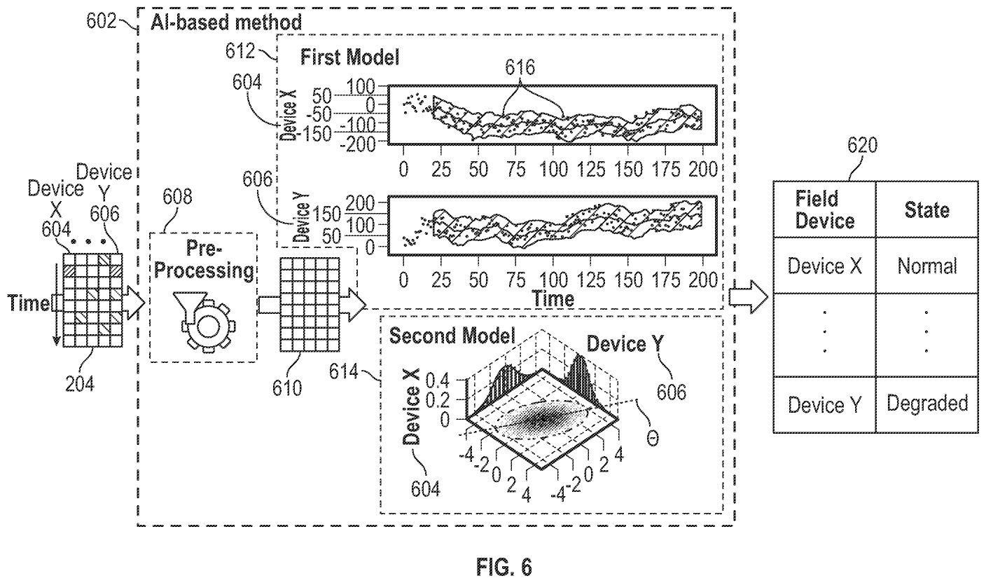

In accordance with one or more embodiments, process variable data (204) from the field devices (206) of an industrial facility (208) are received by the preventative maintenance verification and health validation tool (202) and processed by the field device health evaluator (230). As discussed, the field device health evaluator (230) is composed of both rules-based methods and one or more AI-based methods to evaluate the health of the field devices (206). The rules-based methods have been previously described. FIG. 6 depicts an example of an AI-based method in accordance with one or more embodiments. To begin, the AI-based method (602), which encloses the operations seen in the dashed box of FIG. 6, receives the process variable data (204) for at least two field devices (206) of an industrial facility (208). In FIG. 6 the process variable data (204) is depicted as a collection of time series, one for each field device (206). Each time series represents the values of a process variable associated with a field device in time. In particular, FIG. 6 identifies a time series for a Device X (604) and a Device Y (606), which are field devices (206) of the industrial facility (208).

In accordance with one or more embodiments, as part of the AI-based method (602), the received process variable data (204) may undergo pre-processing (608). Pre-processing consists of preparing the process variable data (204) to be processed by the AI-based models. Pre-processing may include, but is not limited to, numericalization of the data, normalization of the data, and duplication and/or re-shaping of the data. One with ordinary skill in the art will appreciate that many pre-processing techniques exist and the fact that they are not enumerated herein does not impose a limit on the present disclosure. After pre-processing, the process variable data (204) is considered pre-processed data (610). In some embodiments pre-processing of the process variable data (204) is not be required.

In the example of FIG. 6, the pre-processed data (610) is processed by a first model (612) and a second model (614). The first model (612) is an anomaly detection algorithm. One with ordinary skill in the art will recognize that many anomaly detection algorithms exist and may be used as described herein without departing from the scope of the disclosure. The first model (612) tracks the process variable for each device and detects outliers (616). In FIG. 6, to avoid cluttering the figure, only a few outliers are labelled. Generally, an outlier is a data point that resides outside the “normal” bounds of the process variable. In one or more embodiments, the bounds that are considered “normal” for each process variable are determined using historical data. For example, historical data points for a process variable may be collected and the standard deviation of the collection is used to determine the bounds. In this way, the first model (612) may be trained. Generally, it is expected that the process variable(s) of a given field device fluctuate with time. The fluctuations may be the result of process-dependent behavior of the industrial facility (208) and/or random fluctuations. The first model (612) detects deviations that cannot be explained by random fluctuations or process-dependent behavior. In one or more embodiments, the anomaly detection algorithm operates on the process variable(s) of each field device independently. In other embodiments, the anomaly detection algorithm operates jointly on two or more field devices such that detected outliers in one device may help identify outliers in another. In accordance with one or more embodiments, if the number of detected outliers over a pre-configured time period exceeds a threshold, the associated field device is suspected to be degraded/degrading. In one or more embodiments, the associated generated alarm of a field device with suspected degradation determined using the first model (612) is given a medium priority. In one or more embodiments, the first model (612) detects non-stationary behavior in the process variable(s). Non-stationary behavior is identified when a time-series exhibits a time-varying mean and/or time-varying variance.

The second model (614) identifies correlations, or synchronous behavior, between two or more field devices. In one or more embodiments, the second model develops a regression model pairwise between the process variables (of which there are two or more) of the field devices (206). For example, a regression model that predicts the process variable of Device Y (606) given the process variable of Device X (604) is developed using historical and manually validated process variable data (204) for these devices. Then, the recorded process variable of Device Y (606) can be compared to the predicted value using the developed regression model given the process variable of Device X (604). If, the recorded process variable of Device Y (606) and the predicted value diverge beyond a user-supplied threshold, then Device X (604) and/or Device Y (606) may be found to be in a state of suspected degradation. Such a regression model may be created for any pair of field devices (206). In one or more embodiments, the second model (614) identifies correlations between pairs of field devices (206). The correlation may be linear or non-linear. In this case, the correlation between a pair of field devices (206) with a previously detected (i.e., baseline) correlation is monitored. If the correlation between the field devices (206) diminishes (e.g., correlation is half of its original value) then one or more of the field devices (206) may be suspected to be in a state of degradation or error. For example, in FIG. 6 the second model (614) depicts the values of the process variables for Device X (604) and Device Y (606) over a period of time. As seen, as a baseline, the second model (614) determines that a linear correlation exists between Device X (604) and Device Y (606) and that the baseline correlation value is ⊖. With a baseline established, the second model (614) determines the state of Device X (604) and Device Y (606) by continually evaluating the correlation between them and comparing it to the established baseline. In most instances, the second model (614) only operates on pairwise combinations of field devices (206) that have a baseline correlation above a user-specified threshold.

As seen in FIG. 6, the result of the AI-based method (602) is a state identification array (620). The state identification array indicates the state of each field device (206) as determined by the AI-based method (602). In one or more embodiments, the state identification array (620) is further informed by the rules-based methods of the field device health evaluator (230). For example, in one or more embodiments, if a field device (206) is determined to be degraded using either the rules-based method or the AI-based method, then the state identification array (620) lists the state of this field device (206) as degraded. It is noted that while examples herein have categorized the states of field devices (206) as normal or degraded, other state classes may be used without departing from the scope of this disclosure.

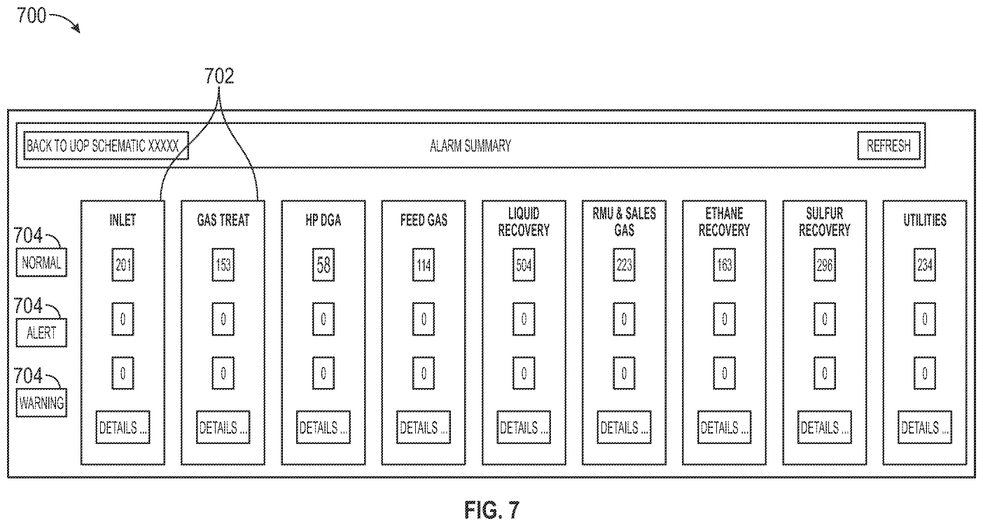

The alarm generator (232) compiles the results of the field device health evaluator (230) and indicates the status and alarm priority of each field device (206) to the operators (214) and/or stakeholders (228). In one or more embodiments, the alarm generator (232) provides a summary of alarms to the facility information system (210) where the summary is visualized using a dashboard (226). FIG. 7 depicts an example alarm summary (700) as produced by the alarm generator (232) upon receiving the results of the field device health evaluator (230). In this example, the alarm summary (700) groups field devices (206) according to their location or function in the industrial facility (208). FIG. 7 depicts various groups (702) of field devices (206). Note that to prevent the cluttering of FIG. 7 not all groups (702) are labelled. The alarm summary (700) of FIG. 7 further groups field devices (206) according to their determined state and alarm priority (704). As seen in FIG. 7, a field device (206) is determined to be either in a normal state or degraded state, where the degraded state is further assigned an alarm priority of “alert” or “warning.” in accordance with one or more embodiments. Thus, the alarm summary (700) indicates the number of field devices (206) with a given state and alarm priority (704) according to their group (702).

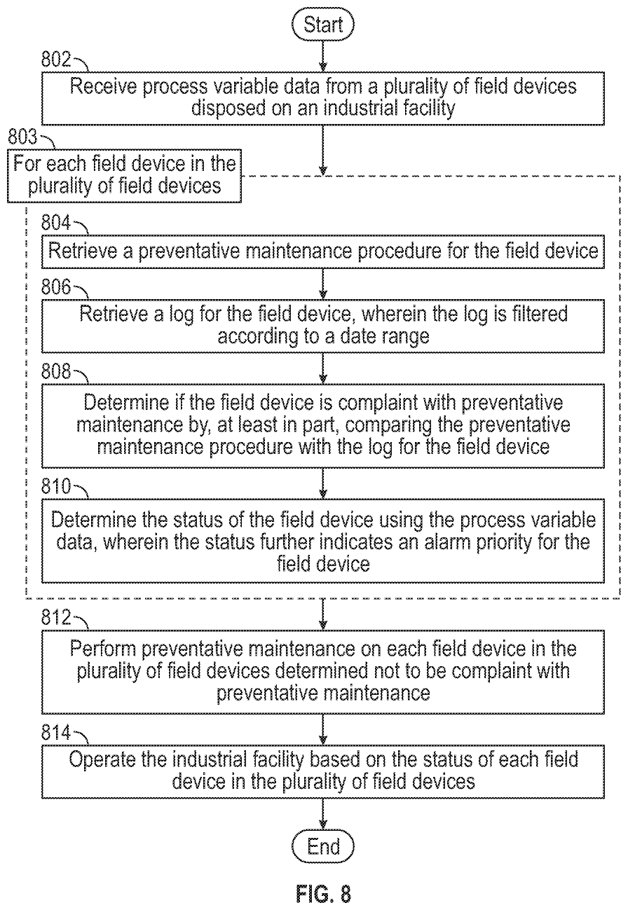

FIG. 8 depicts a flowchart that outlines the use of the preventative maintenance verification and health validation tool (202) in accordance with one or more embodiments. In Block 802, process variable data (204) is received from a plurality of field devices (206) disposed on an industrial facility (208). Once the process variable data (204) has been received, the steps enclosed by the dashed box of FIG. 8 are performed on each field device in the plurality of field devices as indicated by Block 803. The enclosed steps are as follows.

In Block 804, for a given field device, the maintenance procedure for the field device is retrieved from the procedures database (216). In Block 806, the log for the field device is retrieved from the control historian (218). The log is filtered according to a date range. In one or more embodiments, the date range is supplied by a user. The log for the field device may be empty. That is, the log for the field device may contain no records. The log for the field device, if not empty, may contain values for one or more process variables associated with the field device and operator actions associated with, or otherwise applied to, the field device. In Block 808, it is determined if the field device is compliant with preventative maintenance by comparing the preventative maintenance procedure with the log for the field device. In one or more embodiments, the field device can either be found to have had preventative maintenance correctly performed (compliant), to have had preventative maintenance incorrectly performed (non-compliant), or be without records (i.e.; empty log). In Block 810, the status of the field device is determined using the process variable data (204). In one or more embodiments, the status is determined using the field device health evaluator (230) that applies both rules-based and AI-based methods to the process variable data (204) to determine the status of each field device. In one or more embodiments, the status is further associated with an alarm priority. Again, it is noted that Blocks 804 through 810 are applied to each field device in the plurality of field devices. In Block 814, preventative maintenance is performed on each field device in the plurality of field devices that was determined not be compliant.

In one or more embodiments, the report generator (222) provides a summary of the field devices and indicates which field devices, if any, did not have currently performed preventative maintenance (unsuccessful) or did not have a records available to prove that preventative maintenance was correctly performed. In one or more embodiments, the summary is provided to operators (214) of the control system (130) and the operators (214), in coordination with maintenance personnel, follow the PM procedure for each non-compliant field device. In some cases, to perform PM according to the PM procedure, the operators (214) will transmit control signal data (212) using the control system (130).

In Block 814, operation of the industrial facility (208) is informed by and altered according to the determined statuses of the field devices. For example, if a given field device is determined to be in a degraded state, then sub-processes of the industrial facility (208) associated with the affected field device may be bypassed or suspended. In one or more embodiments, the operation of one or more field devices is adjusted through transmission of control signal data (212) from the control system (130) to optimize performance of the industrial facility (208) according to the determined statuses of the field devices. In one or more embodiments, the status of each field device and an associated alarm are generated and raised (or provided) to operators (214) and/or stakeholders (228) of the industrial facility (208).

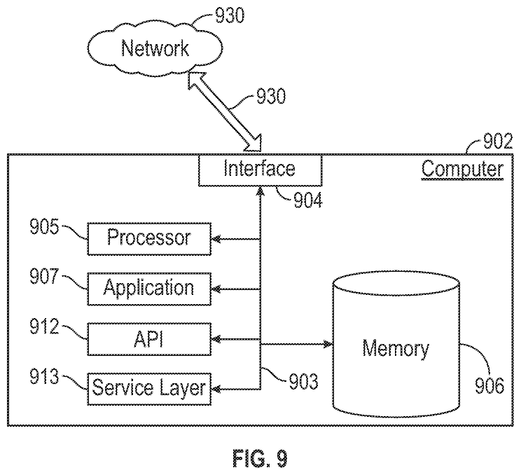

FIG. 9 further depicts a block diagram of a computer system (902) used to provide computational functionalities associated with the methods, functions, processes, flows, and procedures as described in this disclosure, according to one or more embodiments. The illustrated computer (902) is intended to encompass any computing device such as a server, desktop computer, laptop/notebook computer, wireless data port, smart phone, personal data assistant (PDA), tablet computing device, one or more processors within these devices, or any other suitable processing device, including both physical or virtual instances (or both) of the computing device. Additionally, the computer (902) may include a computer that includes an input device, such as a keypad, keyboard, touch screen, or other device that can accept user information, and an output device that conveys information associated with the operation of the computer (902), including digital data, visual, or audio information (or a combination of information), or a GUI.

The computer (902) can serve in a role as a client, network component, a server, a database or other persistency, or any other component (or a combination of roles) of a computer system for performing the subject matter described in the instant disclosure. In some implementations, one or more components of the computer (902) may be configured to operate within environments, including cloud-computing-based, local, global, or other environment (or a combination of environments).

At a high level, the computer (902) is an electronic computing device operable to receive, transmit, process, store, or manage data and information associated with the described subject matter. According to some implementations, the computer (902) may also include or be communicably coupled with an application server, e-mail server, web server, caching server, streaming data server, business intelligence (BI) server, or other server (or a combination of servers).

The computer (902) can receive requests over network (930) from a client application (for example, executing on another computer (902) and responding to the received requests by processing the said requests in an appropriate software application. In addition, requests may also be sent to the computer (902) from internal users (for example, from a command console or by other appropriate access method), external or third-parties, other automated applications, as well as any other appropriate entities, individuals, systems, or computers.

Each of the components of the computer (902) can communicate using a system bus (903). In some implementations, any or all of the components of the computer (902), both hardware or software (or a combination of hardware and software), may interface with each other or the interface (904) (or a combination of both) over the system bus (903) using an application programming interface (API) (912) or a service layer (913) (or a combination of the API (912) and service layer (913). The API (912) may include specifications for routines, data structures, and object classes. The API (912) may be either computer-language independent or dependent and refer to a complete interface, a single function, or even a set of APIs. The service layer (913) provides software services to the computer (902) or other components (whether or not illustrated) that are communicably coupled to the computer (902). The functionality of the computer (902) may be accessible for all service consumers using this service layer. Software services, such as those provided by the service layer (913), provide reusable, defined business functionalities through a defined interface. For example, the interface may be software written in JAVA, C++, or other suitable language providing data in extensible markup language (XML) format or another suitable format. While illustrated as an integrated component of the computer (902), alternative implementations may illustrate the API (912) or the service layer (913) as stand-alone components in relation to other components of the computer (902) or other components (whether or not illustrated) that are communicably coupled to the computer (902). Moreover, any or all parts of the API (912) or the service layer (913) may be implemented as child or sub-modules of another software module, enterprise application, or hardware module without departing from the scope of this disclosure.

The computer (902) includes an interface (904). Although illustrated as a single interface (904) in FIG. 9, two or more interfaces (904) may be used according to particular needs, desires, or particular implementations of the computer (902). The interface (904) is used by the computer (902) for communicating with other systems in a distributed environment that are connected to the network (930). Generally, the interface (904) includes logic encoded in software or hardware (or a combination of software and hardware) and operable to communicate with the network (930). More specifically, the interface (904) may include software supporting one or more communication protocols associated with communications such that the network (930) or interface's hardware is operable to communicate physical signals within and outside of the illustrated computer (902).

The computer (902) includes at least one computer processor (905). Although illustrated as a single computer processor (905) in FIG. 9, two or more processors may be used according to particular needs, desires, or particular implementations of the computer (902). Generally, the computer processor (905) executes instructions and manipulates data to perform the operations of the computer (902) and any algorithms, methods, functions, processes, flows, and procedures as described in the instant disclosure.

The computer (902) also includes a memory (906) that holds data for the computer (902) or other components (or a combination of both) that can be connected to the network (930). The memory may be a non-transitory computer readable medium. For example, memory (906) can be a database storing data consistent with this disclosure. Although illustrated as a single memory (906) in FIG. 9, two or more memories may be used according to particular needs, desires, or particular implementations of the computer (902) and the described functionality. While memory (906) is illustrated as an integral component of the computer (902), in alternative implementations, memory (906) can be external to the computer (902).

The application (907) is an algorithmic software engine providing functionality according to particular needs, desires, or particular implementations of the computer (902), particularly with respect to functionality described in this disclosure. For example, application (907) can serve as one or more components, modules, applications, etc. Further, although illustrated as a single application (907), the application (907) may be implemented as multiple applications (907) on the computer (902). In addition, although illustrated as integral to the computer (902), in alternative implementations, the application (907) can be external to the computer (902).

There may be any number of computers (902) associated with, or external to, a computer system containing computer (902), wherein each computer (902) communicates over network (930). Further, the term “client,” “user,” and other appropriate terminology may be used interchangeably as appropriate without departing from the scope of this disclosure. Moreover, this disclosure contemplates that many users may use one computer (902), or that one user may use multiple computers (902).

Although only a few example embodiments have been described in detail above, those skilled in the art will readily appreciate that many modifications are possible in the example embodiments without materially departing from this invention. Accordingly, all such modifications are intended to be included within the scope of this disclosure as defined in the following claims.

What is claimed is:

1. A method, comprising:
receiving process variable data from a plurality of field devices disposed in an industrial facility;
for each field device of the plurality of field devices:
retrieving a preventative maintenance procedure for the field device,
retrieving a log for the field device, wherein the log is filtered according to a date range,
determining if the field device is compliant with preventative maintenance by, at least in part, comparing the preventative maintenance procedure with the log for the field device, and
determining a status of the field device using the process variable data, wherein the status further indicates an alarm priority for the field device;
performing preventative maintenance on each field device in the plurality of field devices determined not to be compliant with the preventative maintenance procedure of that field device; and
operating the industrial facility based on the status of each field device in the plurality of field devices.

2. The method of claim 1, further comprising generating a preventative maintenance report, wherein the preventative maintenance report indicates a compliance for each field device in the plurality of field devices.

3. The method of claim 1, further comprising generating an alarm for each field device in the plurality of field devices according to its determined status and alarm priority.

4. The method of claim 1, wherein the status of each field device of the plurality of field devices is determined using, in part, an artificial intelligence method.

5. The method of claim 4, wherein the artificial intelligence method is a set of regression models, one for each pair of field devices in the plurality of field devices.

6. The method of claim 1, wherein the status of each field device in the plurality of field devices is determined, in part, by:
calculating a rate of change for the field device over a period of time;
determining, using the rate of change for the field device, if the field device is frozen or halted; and
determining, using the rate of change for the field device, if the rate of change of the field device resides outside an upper bound or a lower bound.

7. The method of claim 1, wherein for each field device of the plurality of field devices, the log for the field device comprises a process variable and operator actions for the field device.

8. The method of claim 6,
wherein if the field device is determined to be frozen or halted, the alarm priority for the field device is set to a high priority, and
wherein if the rate of change of the field device is determined to reside outside the upper bound or the lower bound, the alarm priority for the field device is set to a low priority.

9. The method of claim 4, wherein for any field device determined to be in a degraded status using the artificial intelligence method, the alarm priority for said field device is set to a medium priority.

10. The method of claim 1, further comprising transmitting control signal data to the plurality of field devices, wherein the transmitted control signal data adjusts a behavior of at least one field device in the plurality of field devices, to optimize the industrial facility.

11. A system, comprising:
an industrial facility;
a plurality of field devices, wherein the field devices are disposed in the industrial facility;
a control system, wherein the control system is configured to receive process variable data from at least one of the field devices in the plurality of field devices and transmit control signal data to at least one of the field devices in the plurality of field devices;
a procedures database, wherein the procedures database comprises preventative maintenance procedures for each of the field devices in the plurality of field devices;
a control historian, wherein the control historian comprises a log for each of the field devices in the plurality of field devices; and
a preventative maintenance verification and health validation tool configured to:
receive the process variable data; and
for each field device in the plurality of field devices:
receiving a preventative maintenance procedure for the field device from the procedures database,
receiving a log for the field device from the control historian, wherein the log is filtered according to a date range,
determining if the field device is compliant with preventative maintenance by, at least in part, comparing the preventative maintenance procedure with the log for the field device, and
determining a status of the field device using the process variable data, wherein the status further indicates an alarm priority for the field device.

12. The system of claim 11, wherein the preventative maintenance verification and health validation tool is further configured to generate a preventative maintenance report, wherein the preventative maintenance report indicates a compliance for each field device in the plurality of field devices.

13. The system of claim 11, wherein the preventative maintenance verification and health validation tool is further configured to generate an alarm for each field device in the plurality of field devices according to its determined status and alarm priority.

14. The system of claim 11, wherein the status of each field device of the plurality of field devices is determined using, in part, an artificial intelligence method.

15. The system of claim 14, wherein the artificial intelligence method is a set of regression models, one for each pair of field devices in the plurality of field devices.

16. The system of claim 11, wherein the status of each field device in the plurality of field devices is determined by:
calculating a rate of change for the field device over a period of time;
determining, using the rate of change for the field device, if the field device is frozen or halted; and
determining, using the rate of change for the field device, if the rate of change of the field device resides outside an upper bound or a lower bound.

17. The system of claim 11, wherein for each field device in the plurality of field devices, the log for the field device comprises a process variable for the field device and operator actions for the field device.

18. The system of claim 16,
wherein if the field device is determined to be frozen or halted, the alarm priority for the field device is set to a high priority, and
wherein if the rate of change of the field device is determined to reside outside the upper bound or the lower bound, the alarm priority for the field device is set to a low priority.

19. The system of claim 14, wherein for any field device determined to be in a degraded status using the artificial intelligence method, the alarm priority for said field device is set to a medium priority.

20. The system of claim 11, wherein the preventative maintenance verification and health validation tool is further configured to transmit control signal data to the plurality of field devices, wherein the transmitted control signal data adjusts a behavior of at least one field device in the plurality of field devices, to optimize the industrial facility.
